(19) United States
(12) Patent Application Publication
(10) Pub. No.: US 2010/0306073 A1
(43) Pub. Date: Dec. 2, 2010

(54) IDENTIFYING AND PURCHASING PRE-RECORDED CONTENT

(76) Inventor: Liam Young, Dublin (IE)

Correspondence Address: IP Patent Docketing;K&L GATES LLP, 599 Lexington Avenue, 33rd Floor, New York, NY, 10022-6030, US

(21) Appl. No.: 12/475,348

(22) Filed: May 29, 2009

(51) Int. Cl. G06F 15/16; G06Q 30/00; G06Q 50/00

(52) U.S. Cl. 705/26; 709/206; 709/203; 705/310

(57) ABSTRACT

Example embodiments of the present invention relate to identifying unknown media content. For example, systems and methods are provided which allow for the identification of broadcast content by receiving a request message identifying a content source and a time; identifying a content item broadcast from the content source at the time; retrieving information identifying the content item; creating a response message including the information; and transmitting the response message to a user device.

### BACKGROUND

Persons listening to music, e.g., from a broadcast source such as a radio station, may often be exposed to content with which they are unfamiliar. When listening to such previously unknown music such persons often would like to identify a song currently being played. Frequently, however, the content source does not immediately identify the current selection, e.g., a radio station announcer does not state the title, recording artist, or other information about the song at the moment when the listener is interested in this information. Even if such information were provided, it may have been provided at a time when the user was not yet interested or was not then tuned to that radio station. In order to identify such a song, the listener may therefore need to wait until hearing the song again and hope that the title and artist are announced at that time.

Even when information identifying a song is announced and heard, in some situations, listeners may not be able to easily retain the information, such as when a listener is operating in a noisy environment, such as in an automobile or restaurant, or when a listener does not have a pen and paper at the ready. This situation presents problems to radio listeners, potential music purchasers, and sellers alike.

For instance, a significant number of radio listeners seeking to buy music at record stores or on the Internet are often unable to remember the name of a song or the recording artist at the time they enter a music store or logon to a music download website to purchase the music. Music fans would undoubtedly buy more music if they had immediate information about the title of the song and artist as it is being played, or if they had a mechanism to immediately purchase the music being listened to. Unfortunately, there is currently no convenient way for a music seller to take advantage of a potential music purchase resulting from a listener hearing a song that is remote from normal retail locations or convenient Internet access.

In summary, there exists a time and situation gap between the time a listener hears a song on the radio that they wish to purchase and the time when such a listener is typically in a position to purchase that music. The existence of this gap substantially reduces the likelihood that the listener will eventually purchase the music.

### SUMMARY

Example embodiments of the present invention may provide systems and methods enabling the consumers of content to easily identify and purchase that content.

In example embodiments, a procedure for identifying content is provided, which may include receiving a request message identifying a content source and a time; identifying a content item transmitted from the content source at the time; retrieving information identifying the content item; creating a response message including the information; and transmitting the response message to a user device. In some example procedures, the content source may be a radio station, and the content item may be a musical work. In some example procedures, the request message may be a text message, and the user device may be a mobile telephone. And in some example procedures, the request message may be an SMS message.

In other example embodiments, a system for identifying content may be provided, including a service provider server, and a communications device in communication with the service provider server. In such example embodiments, the service provider server may be configured to receive, using the communications device, a request message identifying a content source and a time; identify a content item transmitted from the content source at the time; retrieve information identifying the content item; create a response message including the information; and transmit the response message to a user device. In some example systems, the content source may be a radio station, and the content item may be a musical work. In some example systems, the request message may be a text message, and the user device may be a mobile telephone. And in some example systems, the request message may be an SMS message.

In other example embodiments, an article of manufacture may be provided. In such example embodiments, the article of manufacture may include a computer readable medium storing a plurality of machine executable instructions which, when executed by a computer, may be configured to cause the computer to receive a request message identifying a content source and a time; identify a content item transmitted from the content source at the time; retrieve information identifying the content item; create a response message including the information; and transmit the response message to a user device.

In other example embodiments, a system for identifying content may be provided, which may include a service provider server, and a communications device in communication with the service provider server. In such example systems, the service provider server may include a device for receiving a request message identifying a content source and a time; a device for identifying a content item transmitted from the content source at the time; a device for retrieving information identifying the content item; a device for creating a response message including the information; and a device for transmitting the response message to a user device.

### BRIEF DESCRIPTION OF THE DRAWINGS

The present invention will be more readily understood from a detailed description of the preferred embodiments taken in conjunction with the following figures:

FIG. 1 illustrates an example procedure for identifying content according to an example embodiment of the present invention.

FIG. 2 illustrates an example system for identifying content according to an example embodiment of the present invention.

FIG. 3 illustrates another example system for identifying content according to an example embodiment of the present invention.

FIG. 4 illustrates an example system for monitoring content sources according to an example embodiment of the present invention.

### DETAILED DESCRIPTION OF EXAMPLE EMBODIMENTS

Example embodiments of the present invention may provide systems and methods which may allow consumers of unknown content, whether from a broadcast source or another content source, to quickly and easily identify such content. In some example embodiments users may be able to identify content by transmitting a text message, email, or other suitable message, to a device by indicating the content source on which the desired content was heard. Such users may be sent a return message identifying the content. In addition, in some example embodiments, users may be provided with the ability to purchase the identified content in a convenient manner.

It is noted that in the discussion that follows a number of example embodiments of the present invention are described with reference to identifying music which may be broadcast by a radio station. The present invention is, however, in no way limited to either music or to radio broadcasts. Rather, other example embodiments apply to both other types of content and to other content sources. For example, other example embodiments may be capable of identifying and providing talk radio programs, television programming, video and audio advertisements, content provided by an Internet source, etc., and such content may be accessed over any suitable communications path, for example, satellite radio, cable televisions systems, the Internet, etc.

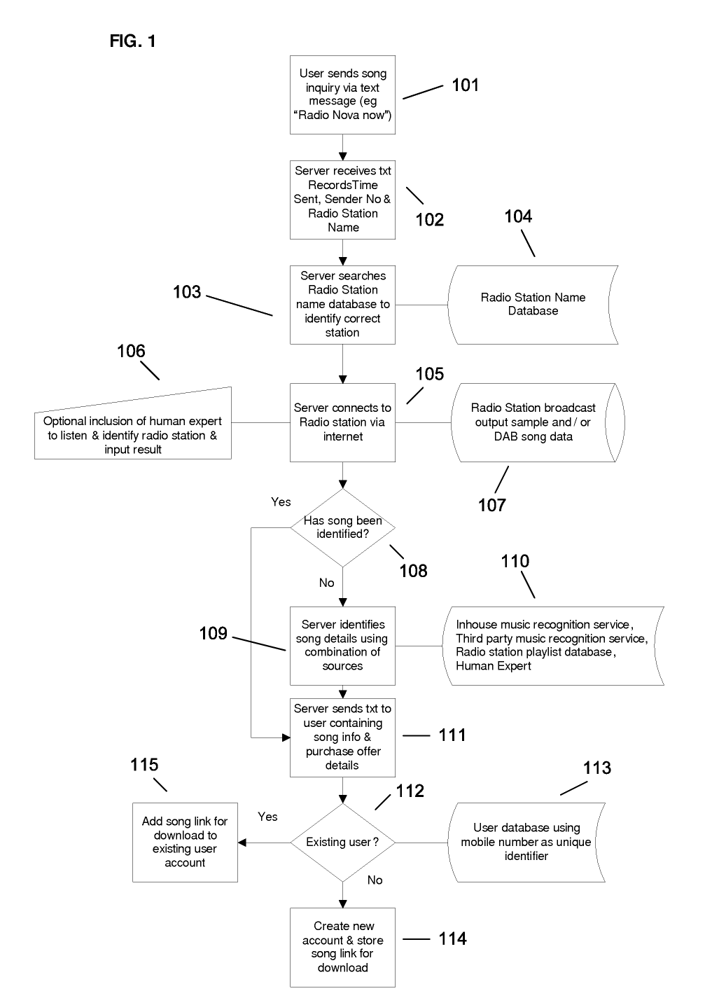

Example embodiments of the present invention may provide for procedures which may allow for the identification and procurement of broadcast or other content. For example, FIG. 1 illustrates an example procedure in accordance with an example embodiment of the present invention. As illustrated, such a procedure may begin when a user sends a text message 101. For example, a user may be listening to song played over a radio broadcast, or may be consuming other content as identified above. If interested in the song, the user may send a text message requesting further information about the song, or seeking to license the song, etc. The text message may be sent using any suitable technology. For example, the text message may be an SMS message sent using a mobile telephone. Other messaging technologies may also be used however. For instance, the user may send a request using email, a messaging service provided by the source of the content, etc. Such messages may be addressed to a service provider device which may have an associated mobile telephone number, email address, etc., which may be made known to potential users of the service.

In example embodiments, the text message may contain information which may allow for identification of the song or other content. For example, such information may include information identifying the source of the content. In the case of a radio broadcast, the text message may contain information identifying a radio station, for instance the call letters of the station, or the frequency on which the station broadcasts. In other examples, a text message may include the name of a service provider, for instance a cable company or a satellite radio service, and may also include a channel number. Such a text message may contain any other information capable of identifying a content source, for instance, the IP address or DNS name of a machine connected to the Internet. Such text messages may contain information identifying a content source which does not directly identify a physical source. For instance, the name of a radio program may be included in a text message which may or may not be carried on multiple radio stations, or other content sources.

In example embodiments, a text message may also include contextual information which may facilitate the identification of content. For instance, a text message may include a time, which may represent a time at which the content of interest was being broadcast, e.g., over a content source identified in the message. Such a time may be entered in a text message by a user, or may be automatically determined, based, for example, on the time at which a message was sent or received. For instance, the sending device or network may place a time stamp in the text message which may indicate the time at which the message was sent. In other cases, the receiving system may record the time at which the message was received. In example embodiments, such automatically determined times may be considered default times, which may be used by the service provider unless a user identified time is presented in the text message. For example, a user may be interested in a song that has played some time ago, rather than the current song. Accordingly, the user may be able to create a text message manually imputing the time of interest, as either an absolute time, or as a relative time, e.g., “15 minutes ago.”

In other embodiments, the text message may include other contextual information. For instance, in some example embodiments, location information may be included in the text message. Such information may be useful for identifying a content source. For instance, should a text message identify a radio station by its broadcast frequency, that frequency may not uniquely identify the station, identifying, rather, a number of radio stations serving different locations. In such cases, location information may further identify the content source. Accordingly, in some example embodiments, a user may enter information in a text message identifying a location. In other examples, such information may be identified through other sources, for example GPS systems, mobile telephone network tower identifiers, IP address, network provider, etc.

Text messages may also include information identifying the content about which information is desired. For instance, the content of interest may not be the current content. Accordingly, a message may include information indicating which content is desired, e.g., the previous song, or the song immediately following the last commercial break. Information may be requested about more than one piece of content. Accordingly, a text message may identify a number of content items, e.g., the last five songs, or the current song and the song played three songs ago, etc.

Referring to FIG. 1, once a user sends a text message, it may be received by a service provider 102. Upon receipt, the service provider may record the information contained in the text message, including any of the information identified above, e.g., a radio station's call letters. The service provider may also record information related to the text message itself or receipt of the message. For instance, the service provider may record a time at which the text message was received. In addition, the service provider may record a source address of the message, e.g., in the case of a text message sent from a mobile phone, a telephone number.

In some examples, recording such information may involve parsing the text message to identify the information contained in it. Some example embodiments may employ a relatively simple parsing process, for example identifying information based on the position of that information in the text message. In other examples, however, parsing the message may be more sophisticated, e.g., text identifying a content source may be identified as such by comparing the text against a list of known content sources. Any technique suitable for parsing text may be used to parse the request messages. In some example embodiments, once parsed, the elements identified in the message may be stored in a request database.

The service provider may then identify a content source 103. For instance, a service provider may maintain lists of content sources, such as a list of radio station names or call letters 104, the names of radio shows, lists of satellite radio service providers, etc. Upon receiving a text message, a service provider may compare the message to the listings in order to identify a content source.

In some example embodiments, a human expert may analyze the text message to determine the intended request 106. For example, should automatic parsing of the message fail to identify a known source, the text message may be transmitted to a human expert for examination. Should the human operator determine the intended request, the operator may record the intended request. In other examples, a human operator may examine selected messages for quality control purposes. For example, an operator may examine every 5,000^{th} message processed, comparing the source identified automatically with the source the operator identifies based on an examination of the message. The operator may then record the concurrence or discrepancy found.

Once a source has been identified, information about the source programming may be collected 105. For instance, an information service provided by the content source may be accessed, e.g., a playlist provided over the Internet. The content itself may also be accessed for direct identification. For instance, the content source may be accessed and the content sampled. In the case of a radio broadcast, the content may be accessed by tuning a receiver to the radio station, or via a web server that also makes available the broadcast content, etc. A sample of the content may then be collected and stored 107. Such gathered content may include both the content itself, e.g., a recording of a song or portion of a song, as well as information accompanying the content, e.g., metadata transmitted along with or embedded in a song.

The example procedure illustrated in FIG. 1 may then determine whether the requested content has been identified 108 based on processing to this point. For example, a record of content which has been identified may be maintained. Accordingly, should a text message request information regarding content which has previously been identified for another request, the information may be provided without further processing. In other examples, a service provider may create and maintain its own playlists for certain content sources, e.g., a service provider may continually gather and identify content from a number of popular radio stations. The service provider may, therefore, have preassembled a playlist for those content sources. Should a text message request information regarding content from one such content source, the information may be provided by referencing the maintained list without further processing. If the content has been identified, the example process shown in FIG. 1 may proceed to complete the user's request 111. If, however, the content has not been identified, an attempt to identify the requested content may be made 109 using various techniques and resources 110, alone or in combination.

For example, the content may be identified based on information gathered from an information service provided by the content source, as mentioned above. For instance, in the case of a radio station which makes its playlist available, that playlist may be used to identify the content. In such a case, a time associated with a user's request may be matched with times listed in the playlist in order to identify the content playing at the user indicated time. Other information provided by a content source may be used to identify the content as well.

The content may also be identified by metadata transmitted with the content, either embedded in the content itself or using a separate encoding system. Again taking the example of a song transmitted over a radio station, the radio station may include identifying information in the transmission, e.g., the station may indicate the name of the song, the performing artist or group, the genre of the song, etc. Such information may be extracted from the content and may be used to identify the content. It is noted here that such identifying content need not be transmitted concurrently with the content to be identified. For example, the identifying information may be transmitted preceding transmission of the content. Accordingly, example processes may seek such data during a predetermined time period surrounding the presentation of content.

In addition, in some examples, content received from the content source may be identified using content recognition systems and techniques. For instance, the content itself may by analyzed and compared to a list of known content. A list of known content may be maintained along with data identifying properties of the content itself, for example, a sample of the content, or an average signal level of the content signal, etc. The content identified as the target of the user's request may be analyzed and compared to the content identifiers stored in the database. Should a match be found, example embodiments may retrieve identifying information which may be related to the matched content.

Content related to a user request, and received from a content source, may also be transmitted to a third party content recognition service for identification 110. Here, the content that is to be identified may be transmitted to a third party service in any useful way, for example over the Internet. The entire piece of content need not be transmitted, for instance, a portion of the content may be transmitted to the third party service. Alternatively a signal derived from the content may be transmitted, for example a signal created using a fingerprinting technique. The third party service may then attempt to identify the content, returning a positive identification or an indication of failure.

A human expert may also identify the content 110. For example, the content received from a content source may be presented to the operator who may have knowledge of existing content. The operator may be able to identify the content using that knowledge. In other examples, the user may be presented with the content along with a number of possible identifications made using other techniques, allowing the operator to choose between the possible identifications when other techniques were unable to uniquely identify the content.

In example embodiments, all or any of the techniques described above, as well as other techniques suitable for identifying the type of content under consideration, may be employed individually or in combination. For example, the techniques described above may be employed in hierarchical fashion, applying one technique first, e.g., attempting to identify the content based on an information service provided by the content source. Should that technique yield an identification, the content may be considered identified and processing may proceed. However, if the technique fails, an attempt to identify the content using another technique in the hierarchy may be made, until the content is positively identified, or until all techniques are exhausted. The ordering of such a hierarchy may be based on any logical ordering. For example, the least resource intensive techniques, or the most accurate, etc., may be tried first. In addition, in some example embodiments, if a first technique yields an identification, other techniques may also be employed to verify whether those techniques result in an identification that agrees with the first result.

As illustrated in the example procedure shown in FIG. 1, once a positive identification of the requested content is made, the user request may be responded to 111. For example, a text message containing information identifying the content may be constructed and transmitted to the requesting user. For example, in the case of a song, a text message can be constructed and may include the title of the song, the album or albums on which the song appears, the genre of the song, the performing artist or group, the date of publication, etc. The responding message may be sent to the user device sending the initial request. For example, the message may be addressed to a cell phone number from which the user request was sent. Alternatively the return message may be sent to one or more specified addresses. For instance, the user request message may include one or more return addresses, e.g., mobile phone numbers, email addresses, etc. In addition, in some embodiments, users may maintain accounts which may specify a default return address to which such text messages are to be sent, e.g., an email address to which a response should be returned.

In some example embodiments, response messages may also include an offer to purchase, license, download, or otherwise obtain the content identified and/or rights in the content. For instance, a response message may present the user with pricing information and other details relating to the download, purchase, or license of the content. Such a message may include details as to how to accept the offer. For instance, the message may identify a website which the user may access, which may allow the user to obtain the content. The message may also describe the terms under which the offered content may be used, the format in which the content may be obtained, and any other information relating to the obtainment of content.

For example, as depicted in FIG. 1, once the content has been identified, it may be determined whether the user is an existing user 112, which may be determined based on, e.g., the mobile telephone number or email address that the request was sent from, etc. If the user is not an existing customer, a new user account may be created 114. The new account may be created using an identifier of the user's sending device or account, e.g., mobile phone number. A response message may then include instructions on how to access the newly created account, for instance, providing an address of a website through which the account is accessed, login information, etc. The user account may allow the user to access the identified content. For instance, in the case of an account accessed by a webpage, an account webpage may contain a link allowing the user to license and obtain the desired content. Of course, in order to actually access the content, users may be required to provide payment information, identifying information, etc.

Should it be determined that the user already has an account, the user's account may simply be updated with a reference to the identified content 115. For instance, in the case of a user account accessible through a website as described above, an account webpage may simply be updated to allow access to the identified content. In such examples, a user may then be presented with the opportunity to obtain the new content the next time the user accesses the account.

In other example embodiments, the response message may indicate that the user is able to obtain the content according to certain terms by sending another message of some kind (or simply by indicating that the content is to be acquired in the original message). For instance, the response message may indicate that if the user replies with a message indicating agreement to license, purchase, or otherwise obtain the content, the content may be delivered. For instance, if the user maintains an account of the sort discussed above, the user may automatically obtain access to the content and have that content made available through the account by indicating the desire to obtain the content in a text message. In such embodiments, the user account may be charged for any costs associated with obtaining the content. In other example embodiments, users may be able to obtain access to content without an account with a service provider. For example, in the case of a mobile phone user who indicates a desire to obtain content, the content may be delivered directly to the mobile phone and the user may be charged by adding a charge to the user's mobile telephone bill.

In any case, should the user obtain access to the content, access to the content itself may be provided in any suitable manner. For instance, the user may be provided with a link to a website from which the content may be downloaded. In such a case, a message may be sent to the user containing an access code or password allowing access to the content. Alternatively, the content may be transmitted to an email address, may be made available on a subscription service, or may be transmitted to a user device, e.g., may be uploaded to the user's mobile phone. In yet other examples, the desired content may be provided in the form of physical media, for instance, a CD or DVD which may be mailed to the user, etc.

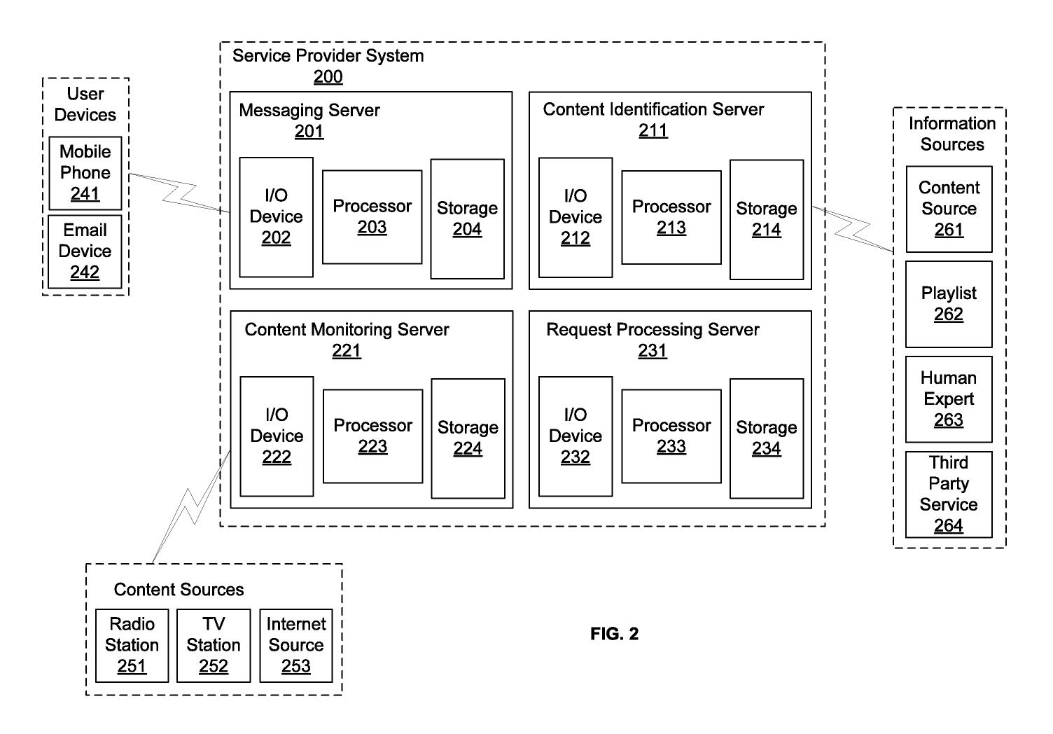

Other example embodiments may provide systems which may be capable of processing user requests. For example, FIG. 2 illustrates an example system 200 according to an example embodiment of the present invention. The system 200 illustrated in FIG. 2 may be configured to receive user requests in the form of textual messages, as described above.

For example, the system may include a messaging server 201. Such a messaging server 201 may include one or more I/O devices 202, which may, for example, connect the server to a communications network using which the messaging server 201 may send and receive text messages. For instance, a messaging server 201 may be in communication with a mobile telephone network, over which it may receive text messages from the users of mobile telephones 241 on the network and other networks. Such messaging servers 201 may also be connected to other communications networks. For instance, a messaging server 201 may be connected to the Internet, or another data network, over which it may be able to send and receive email messages, or other data messages. Such messaging servers 201 may be connected to any number of communications networks. In addition, messaging servers 201 may include a processor 203 and a storage device 204. Messaging servers 201 may be configured to receive messages from users. Upon receiving such messages, example messaging servers 201 may be configured to store such messages, and may also store information regarding the receipt of such messages. For instance, the messaging server may record the time at which each message was received, the address from which the message was received, and any other relevant information.

Some example systems 200 may also include a system capable of identifying content, for instance, a content identification server 211, either integrated with or separate from the other components of the system. Such a content identification server 211 may also include one or more I/O devices 212 which may, facilitate communications with a messaging server 201 or other devices. Content identification servers 211 may be configured to receive content identification requests from users. For instance, content identification servers 211 may be configured to receive content requests in their original form, may be configured to receive parsed messages, or may be configured to receive recorded content itself, etc. The content identification servers 211 may be configured to process the information received to identify the requested content. Accordingly, content identification servers 211 may be configured to communicate with content sources 261, third party identification systems 264, or other resources needed to identify content, e.g., according to any of the techniques described above. In some examples, content identification servers 211 may include storage devices 214, and may be configured to keep a record of the content requests received and the identifications made.

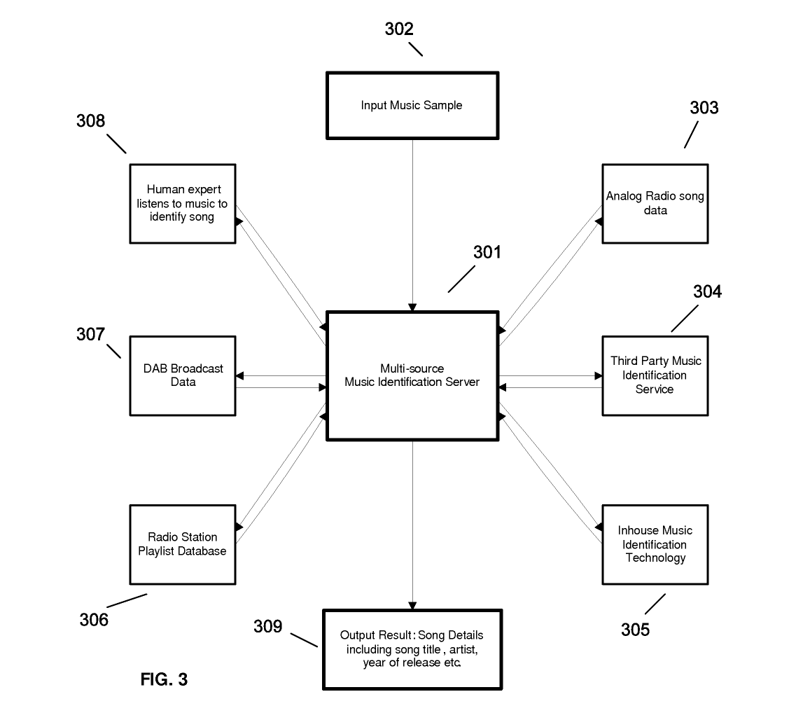

For example, FIG. 3 illustrates an example Multi-Source Music Identification Server (MSMI) 301 in accordance with an example embodiment of the present invention. It is again noted that the example is described in terms of a music processing system for illustrative purposes only, and that other example embodiments may provide systems which may identify other types of content. The MSMI 301 illustrated in FIG. 3 may include one or more I/O devices which may allow the MSMI to receive content, identify content, and transmit identifications. For example, the MSMI 301 may include networking devices, serial devices, busses, etc. The MSMI 301 may be configured to receive information identifying content to be identified and may also be configured to receive the content or a sample of the content itself 302. The MSMI 301 may include a storage system configured to store the content received and may further include a processor which may be configured to facilitate the identification of content.

MSMIs 301 may be capable of performing a number of techniques to identify content. For example, an MSMI 301 is shown in FIG. 3 as being capable of identifying content through the use of Analog Radio Song Data 303. For instance, the MSMI 301 may be configured to receive content broadcast as an analog radio signal. Of course the MSMI 301 may itself be capable of accepting the content in any suitable form, for instance, as a digitized representation of the original signal. The MSMI 301 may be configured to extract identifying information encoded in such an analog signal, for instance a song title, artist, or other information. As noted above, such information may not be included in the signal contemporaneously with the content itself. Accordingly, the content provided to the MSMI 301 may include content surrounding the actual content to be identified, e.g., by a predetermined amount of time.

Similarly, an example MSMI 301 may be capable of extracting information about content included in a digital broadcast. Content transmitted in a digital format may include data identifying data, encoded in either the content itself or separately from the content, which may be extracted by an MSMI. For example, the MSMI 301 depicted in FIG. 3 is shown as being able to access information included in DAB (Digital Audio Broadcasting) content 307. As above, example systems may be configured to extract such information from the content and may be capable of using such information to identify the content.

An MSMI 301 may also be capable of interfacing with one or more Third Party Music Identification Services 304. For instance, the MSMI 301 may be configured to connect to a third party service over a network, for instance the Internet. The MSMI 301 may be configured to provide the service with the necessary content. For example, the MSMI 301 may transmit to the third party service the content it received or a portion of the content. The MSMI 301 may also be able to processes the content before producing it, for example, encoding the content in a particular format, or generating a fingerprint, or other derived representation of the content, for transmission to the service. The MSMI 301 may also be capable of receiving and storing an identification from the service, or an indication that identification has failed.

An MSMI 301 may also be capable of processing the received content itself 305. For instance, the MSMI 301 may be capable of using signal processing techniques to identify the content. Here the MSMI 301 may have access to a database, either contained locally in a storage device, or remotely accessible. The database may include identification records for known content items. For instance, such a database may contain a list of known musical works, identified by title, artist, album, genre, etc. Such a database may also record information identifying the content itself, for instance, a fingerprint of the content, a portion of the content, or information describing the content. Accordingly, the MSMI 301 may be capable of analyzing the content received to determine whether the content matches information stored in the database. If so, the MSMI 301 can retrieve the information identifying the content.

MSMIs 301 may also be capable of connecting to content source systems and gathering information provided by those sources. For example, an MSMI 301 may be able to connect to a radio station database containing the station's playlist 306. Accordingly, the MSMI 301 may use such information to identify the content directly from the information provided. For example, the MSMI 301 may correlate the time of the request to the play times listed in the database in order to identify the content.

MSMIs 301 may also be capable of enlisting the services of a human expert operator 308. For example, the MSMI 301 shown in FIG. 3 may be capable of transmitting the content to be identified to a terminal which may be capable of presenting the content to an operator. If the content is recognized, the operator may then be capable of entering information identifying the content which may be transmitted to the MSMI 301. The MSMI 301 can then use and store that identification.

MSMIs 301 may also be capable of outputting the determined identification 309. For example, an MSMI 301 may be capable of transmitting identifying information to another component of the system. The transmitted information may include any information identifying the content, including, for example, a song title, artist, etc., and may also include proprietary identifying information, e.g., an identification number assigned to the piece of content.

Some example systems may also include a system for gathering and maintaining information about content sources, thus, in effect, pre-identifying content. Referring again to FIG. 2, the system 200 may include a content monitoring server 221, which again may be implemented separately from the other devices discussed or may be implemented as an integrated device. Such a content monitoring server 221 may include one or more I/O devices 222 which may be in communication with content sources. The content monitoring server 221 may be capable of receiving content from radio stations 251, television stations 252, Internet sources 253, etc. The content monitoring server 221 may be capable of periodically accessing such content sources in order to create a playlist for each content source which the server 221 is configured to monitor.

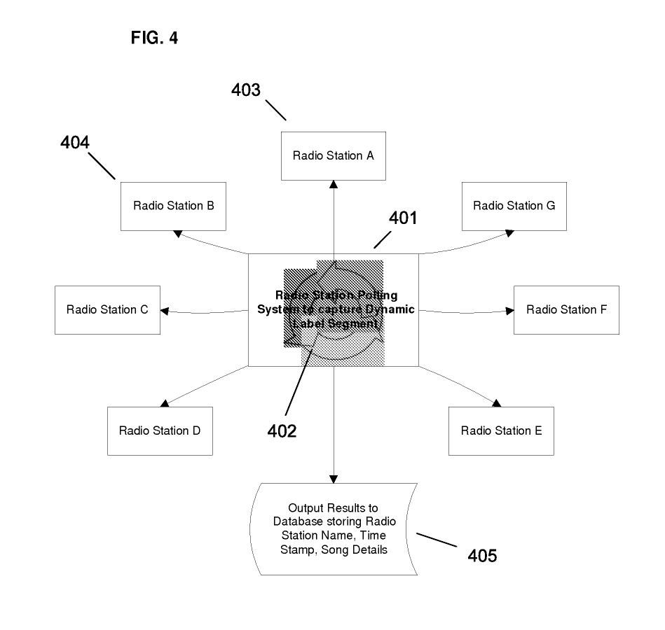

For example, a Radio Station Polling System (RSPS) 401 is illustrated in FIG. 4. The RSPS 401 may include a server, which may be distinct from the other devices described above, or may be integrated into those devices. Such an RSPS 401 may include I/O devices capable of gathering information about content sources, e.g., one or more radio stations.

For instance, an RSPS 401 may include one or more radio tuners which can receive analog radio, digital radio, etc. Such tuners may be integrated into the RSPS, or the tuners may be external devices in communication with the RSPS. The RSPS 401 may be able to receive from the tuners the content currently being broadcast on one or more radio stations. Using the received content, the RSPS 401 can build a listing of content which was presented on various radio stations. Of course, content may be accessed in any suitable way. For instance, the RSPS 401 may also be configured to access content over the Internet, e.g., in the case of radio stations that make content available from an alternative Internet source.

RSPSs 401 may maintain lists of radio stations for which they are to gather content. For instance, an RSPS 401 may include a storage device, storing a listing of radio stations including, e.g., a name of each radio station, a broadcast frequency for the radio station, and any other appropriate information. The RSPS 401 may then monitor each station in an attempt to identify content. For example, the RSPS 401 may direct one or more tuners to receive a particular station or stations. The RSPS 401 may then receive the content currently broadcast on each station. Upon receiving the content, the RSPS 401 may attempt to identify the content so received. For instance, the RSPS 401 may look for identifying information encoded in the content itself, or may use any other technique to identify the content received, for example, the techniques described above.

Should the RSPS 401 identify the content on a station it may record that identification. For instance, if the RSPS 401 identifies a song on a particular station 403 it may store the name of the song or another identifier, and may also store the station on which the song was playing and the time at which it was playing, along with any other information which it may collect. In such a way the RSPS 401 can itself create a playlist for a particular radio station 403 which may be used to identify the content of a user request. Once the RSPS 401 has made an identification, or after a certain amount of time has passed, etc., the RSPS 401 may select another station 404, repeating the process. In this way, the RSPS 401 may generate a playlist for a number of radio stations. Information may be gathered from each source repeatedly 402, e.g., in a cyclical polling process, allowing for the creation of playlists over time.

Returning to FIG. 2, example embodiments of the present invention may also include a request processing server 231, which may be capable of processing user requests, and which may again be a distinct element of the system or may be integrated with other portions of the system. Once requested content has been identified, such a request processing server 231 may be capable of responding to the requester regarding that content, e.g., through a messaging server 201. For instance, the request processing server 231 may be configured to create a response text message responding to the request message. As discussed above, such a message may include information identifying the content. Also as explained above, such response messages may also include information informing users how to purchase or otherwise obtain access to the identified content.

Request processing servers 231 may include storage devices 234, which can store lists of content which may be made available to customers. For example, the storage 234 may store a listing of information identifying musical works, televisions programs, etc., which may be made available to requesters. The content itself may also be stored, as may other information regarding the content, such as the terms under which such content may be offered, copyright information, etc. Should a user request be identified as a request for content which may be supplied to the user, a request processing server 231 may create a message informing the user of the manner in which the content may be obtained. Such request processing servers 231 may also facilitate the provisioning of content.

In some examples, a request processing server 231 may maintain user accounts, or may be in communication with a system maintaining user accounts. For instance, the request processing server 231 may store account information for various users of the service, which may include identifying information, content information, payment information, etc. In response to an identification request, the request processing server 231 may create or update a user account as described above, in order to provide a user with access to the content identified. In some examples, the request processing server 231 can be configured to deliver the content identified to a user device. For instance, as described above, the request processing server 231 may be configured to transmit content to a user's mobile phone.

It will be appreciated that all of the disclosed methods and procedures described herein may be implemented using one or more computer programs or components. These methods and procedures may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It will further be appreciated that the above-described methods and procedures may be provided using the systems disclosed herein, or on other types of systems. The methods and procedures, unless expressly limited, are not intended to be read to require particular actors or systems performing particular elements of the claimed methods.

In the preceding specification, the present invention has been described with reference to specific example embodiments thereof. It will, however, be evident that various modifications and changes may be made thereto without departing from the broader spirit and scope of the present invention as set forth in the claims that follow. The specification and drawings are accordingly to be regarded in an illustrative rather than restrictive sense.

1. A method of identifying content, comprising:
receiving a request message identifying a content source and a time;
identifying a content item transmitted from the content source at the time;
retrieving information identifying the content item;
creating a response message including the information; and
transmitting the response message to a user device.

2. The method of claim 1 wherein:
the content source is a radio station; and
the content item is a musical work.

3. The method of claim 2 wherein:
the request message is a text message; and
the user device is a mobile telephone.

4. The method of claim 3 wherein the request message is an SMS message.

5. The method of claim 2 wherein identifying the content item further comprises accessing a playlist of the content source.

6. The method of claim 2 wherein identifying the content item comprises:
receiving a portion of the content item from the content source; and
identifying the content item based on the portion of the content item.

7. The method of claim 6 wherein identifying the content item further comprises:
identifying the content item based on metadata encoded in the portion of the content item.

8. The method of claim 2 further comprising including in the response message an offer to license the content item.

9. The method of claim 8 further comprising including in the offer to license the content item, a link to a webpage from which the content item may be obtained.

10. A system for identifying content, comprising:
a service provider server; and
a communications device in communication with the service provider server;
wherein the service provider server is configured to:
receive, using the communications device, a request message identifying a content source and a time;
identify a content item transmitted from the content source at the time;
retrieve information identifying the content item;
create a response message including the information; and
transmit the response message to a user device.

11. The system of claim 10 wherein:
the content source is a radio station; and
the content item is a musical work.

12. The system of claim 11 wherein:
the request message is a text message; and
the user device is a mobile telephone.

13. The system of claim 12 wherein the request message is an SMS message.

14. The system of claim 11 wherein the service provider server is further configured to identify the content item by accessing a playlist of the content source.

15. The system of claim 11 wherein the service provider server is further configured to identify the content item by:
receiving a portion of the content item from the content source; and
identifying the content item based on the portion of the content item.

16. The system of claim 15 wherein the service provider server is further configured to identify the content item based on metadata encoded in the portion of the content item.

17. The system of claim 11 wherein the response message includes an offer to license the content item.

18. The system of claim 17 wherein the offer to license the content item includes a link to a webpage from which the content item may be obtained.

19. An article of manufacture including a computer readable medium storing a plurality of machine executable instructions which, when executed by a computer, are configured to cause the computer to:
receive a request message identifying a content source and a time;
identify a content item transmitted from the content source at the time;
retrieve information identifying the content item;
create a response message including the information; and
transmit the response message to a user device.

20. A system for identifying content, comprising:
a service provider server; and
a communications device in communication with the service provider server;
wherein the service provider server includes:
means for receiving a request message identifying a content source and a time;
means for identifying a content item transmitted from the content source at the time;
means for retrieving information identifying the content item;
means for creating a response message including the information; and
means for transmitting the response message to a user device.
